(19) United States
(12) Patent Application Publication
(10) Pub. No.: US 2024/0138047 A1
(43) Pub. Date: Apr. 25, 2024

(54) ELECTRODES FOR A PLASMA ARC PROCESSING SYSTEM

(71) Applicant: Hypertherm, Inc., Hanover, NH (US)

(72) Inventors: Tyler Garrow, Vershire, VT (US); Terence O'Neil, Lebanon, NH (US); John Peters, Canaan, NH (US); Mike Sundstrom, Enfield, NH (US); Brian Currier, Newport, NH (US)

(21) Appl. No.: 18/382,355

(22) Filed: Oct. 19, 2023

Related U.S. Application Data
(60) Provisional application No. 63/418,122, filed on Oct. 21, 2022.
(60) Provisional application No. 63/418,164, filed on Oct. 21, 2022.

(51) Int. Cl. H05H 1/28; H05H 1/34; H05H 1/36

(52) U.S. Cl. CPC H05H 1/28; H05H 1/3423; H05H 1/3447; H05H 1/36

(57) ABSTRACT

An electrode for a liquid-cooled plasma arc torch is provided that includes a torch body and a cathodic element. The electrode includes an electrode body having a proximal end and a distal end extending along a central longitudinal axis. The electrode also includes a retention region located at the proximal end of the electrode body. The retention region is shaped to engage a first portion of the torch body for retaining the electrode within the torch body. The electrode additionally includes a current interface region located axially proximal to the retention region on the electrode body. The current interface region configured to slidably engage a second portion of the torch body while electrically communicating with the cathodic element of the plasma arc torch. The electrode further includes a sealing member circumferentially disposed about the electrode body. The sealing member is located axially distal to the current interface region and the retention region.

### CROSS REFERENCE TO RELATED APPLICATION

This application claims the benefit of and priority to U.S. Provisional Patent Application Nos. 63/418,122 and 63/418,164, both filed on Oct. 21, 2022, the entire contents of both of which are owned by the assignee of the instant application and incorporated herein by reference in their entireties.

### TECHNICAL FIELD

The present invention generally relates to one or more electrode designs for a liquid-cooled plasma arc processing system. The technical advantages of the instant electrode designs include providing sufficient and consistent electrical current path(s) between the electrode and torch body of a plasma arc torch to enable torch operations, while preserving existing connection mechanisms and/or despite any incomplete installation of the electrode within the torch body.

### BACKGROUND

Material Processing heads, such as plasma torches, water jet cutting heads, and laser heads, are widely used in the heating, cutting, gouging and marking of materials. For example, a plasma arc torch generally includes electrical connections, passages for cooling, passages for arc control fluids (e.g., plasma gas), and consumables, such as an electrode and a nozzle having a central exit orifice mounted within a torch body. Optionally, a swirl ring is employed to control fluid flow patterns in the plasma chamber formed between the electrode and the nozzle. In some plasma arc torches, a retaining cap can be used to maintain the nozzle and/or swirl ring in the torch body.

During plasma cutting using a plasma arc torch, an electrical current is transferred between an electrode and a torch body to enable plasma cutting. Thus, sufficient physical contact between the electrode and the torch body is needed to support such current transfer. In some torches, this physical contact may occur at a thread region where the electrode is threaded into the torch body. However, this conductive path is susceptible to inconsistencies due to debris and/or insufficient contact between the electrode and the torch body (e.g., when the electrode is threaded into the torch body by less than 360 degrees, such as about 90 degrees). For example, an electrode or another torch consumable can be subject to loose/incomplete installation to the torch body and/or arcing on the threads if the consumable is not properly tightened or comes loose during torch usage. In these cases, circuit continuity can be broken, leading to a poorly established conductive path through the torch, thereby causing arcing to occur that can create intense heat within the torch, subsequently damaging the torch and consumables as well as reducing cut quality of the plasma processing system during operation and thus quality of parts produced by the plasma processing system. Therefore, systems and methods are needed to provide sufficient and consistent current path(s) between the electrode and torch body of a plasma arc torch while preserving existing connection mechanisms (e.g., a thread connection by less than 360 degrees, such as about 90 degrees).

### SUMMARY

The present invention establishes multiple conductive paths for electrical energy transfer between the electrode and torch body of a plasma arc torch. Embodiments of the invention include electrodes designed to increase/improve electrical contact with the plasma arc torch and enhance their retention within the plasma arc torch.

In one aspect, an electrode for a liquid-cooled plasma arc torch is provided. The torch includes a torch body and a cathodic element. The electrode comprises an electrode body having a proximal end and a distal end extending along a central longitudinal axis. The distal end includes at least one emissive insert disposed therein proximate to a distal tip of the electrode body. The electrode includes a retention region located at the proximal end of the electrode body. The retention region is shaped to engage a first portion of the torch body for retaining the electrode within the torch body. The electrode also includes a current interface region located axially proximal to the retention region on the electrode body. The current interface region is configured to slidably engage a second portion of the torch body while electrically conducting with the cathodic element of the plasma arc torch. The electrode further includes a sealing member circumferentially disposed about the electrode body. The sealing member located axially distal to the current interface region and the retention region on the electrode body.

The current interface region can be located proximal to (i.e., rearward of) both the retention region and the sealing member. The current interface region can comprise an electrically conductive, circumferential surface on an extended portion at the proximal end of the electrode. In some embodiments, the current interface region can be shaped to have a slight bevel, which increases the wall thickness of the electrode from the proximal end toward the distal end along the surface of the current interface region. In some embodiments, the current interface region can comprise any number of features, including grooves, convex profiling, concave profiling, etc., to promote electrical conduction and/or retention between the electrode and the torch body. In some embodiments, the current interface region has a non-circular cross section, but still maintains a maximum-inscribed, circular cross-sectional portion to form an interference fit with the pliable component. For example, the current interface region can be hexagonal in cross-sectional shape with peaks of the hexagon configured to contact and form an interference fit with the pliable component. The axial length of the current interface region can be between about 5% and about 15% of the entire axial length of the electrode. In some embodiments, the pliable component us coupled to the electrode instead of disposed within the torch body.

The retention region can include at least one thread or detent configured to engage a complimentary feature of the torch body, such as a complementary thread or detent, for the purpose of physically securing the electrode to the torch body. In some embodiments, the threads can be discontinuous. Alternatively, the electrode does not have any threads in the retention region and instead has a smooth surface that engages the pliable component via an interference fit. In some embodiments, engagement between the electrode and the torch body via the retention region creates another interface through which electrical current can be conducted therebetween. This current interface can be in addition to or in place of the current conduction path created between the current interface region of the electrode and the pliable component of the torch body.

In some embodiments, upon achieving the secure engagement between the electrode and the torch body, the sealing member is adapted to be compressed to allow physical contact between the torch body and the electrode about the sealing member, thereby creating yet another current interface between the electrode and the torch body. This current interface can be in addition to the two current interfaces described above (i.e., via the retention region and the current interface region of the electrode) or replace one or both of the current interfaces.

In some embodiments, the electrode is substantially symmetrical about the central longitudinal axis. In some embodiments, the current interface region comprises about 11% of an axial length of the electrode. In some embodiments, the retention region comprises about 11% an axial length of the electrode. In some embodiments, a ratio of an axial extent of the retention region to an axial extent of the current interface region is about 1:1.

In some embodiments, the current interface region of the electrode is directly cooled by a liquid coolant. In some embodiments, about 22% of an axial length of the electrode is liquid cooled on an external surface of the electrode, and about 95% of the axial length of the electrode is liquid cooled on an internal surface of the electrode. In some embodiments, about 78% of the axial length of the electrode is gas cooled on an external surface of the electrode.

In some embodiments, the electrode further includes a pliable component disposed about the current interface region to electrically conduct with the cathodic element while matingly engaging the torch body. The pliable component can be a spring or a Louvertac® band.

In some embodiments, the retention region of the electrode comprises a thread or detent. The retention region is configured to engage a complimentary feature of the torch body. In some embodiments, upon engagement between the electrode and the torch body, physical contact between the thread or detent and the first portion of the torch body creates a second current interface region. In some embodiments, upon engagement between the electrode and the torch body, the sealing member is adapted to be compressed to allow physical contact between the torch body and the electrode about the sealing member, thereby creating a third current interface region. In some embodiments, the retention region further comprises an axial stop disposed axially distal to the thread or detent toward the distal end of the electrode body. In some embodiments, an axial distance between the axial stop and the proximal end of the electrode is between about 0.3 inches and about 0.5 inches, such as about 0.4 inches. The axial stop is configured to stop the axial advancement of the electrode within the torch body during installation of the electrode within the plasma arc torch. For example, the electrode, once encounters the axial stop, signals to the operator to rotate the electrode within the torch body to securely engage the threads in the retention region of the electrode with the complementary threads within the torch body. Thus, the axial stop can suitably locate the electrode within the torch to ensure adequate spacing of the electrode relative to other torch components. In some embodiments, the sealing member is an O-ring. In some embodiments, the sealing member is configured to fluidly isolate the current interface region from a plenum of the plasma arc torch. In some embodiments, at least about 22% of an axial length of the electrode is located proximal to the sealing member. In some embodiments the electrode comprises a proximal portion and a distal portion. The proximal portion may extend from the sealing member to the proximal end. The proximal portion may include the current interface region. The distal portion may extend from the sealing member to the distal end tip. The distal portion is configured to seal, isolate, and direct one or more gas or liquid flows about the plasma arc torch. In some embodiments, the electrode further includes a second sealing member circumferentially disposed about an external surface of the electrode at a widest diameter of the electrode.

In another aspect, a method is provided for enabling electrical conduction and engagement between an electrode and a plasma arc torch that includes a torch body and a cathodic element. The method comprises providing the electrode having an electrically conductive body defining a proximal end and a distal end extending along a central longitudinal axis. The distal end includes at least one emissive insert disposed therein proximate to a distal tip of the electrode body. The method also includes axially inserting the electrode into the cathodic element of the plasma arc torch and engaging a retention region of the electrode body with a corresponding first portion of the cathodic element to retain the electrode within the torch body. The retention region is located at the proximal end of the electrode body. The method also includes slidably engaging a current interface region of the electrode body with a second portion of the torch body, while establishing a first current conduction path between the electrode and the cathodic element of the plasma arc torch. The current interface region of the electrode body is located axially proximal to the retention region. The method further includes compressing a sealing member circumferentially disposed about the electrode body upon engagement between the electrode and the plasma arc torch to form a seal therebetween. The sealing member is located axially distal to the current interface region and the retention region of the electrode body.

In yet another aspect, a method is provided for enabling electrical conduction and engagement between an electrode and a plasma arc torch that includes a torch body and a cathodic element. The method includes providing the electrode having an electrically conductive body defining a proximal end and a distal end extending along a central longitudinal axis. The distal end includes at least one emissive insert disposed therein proximate to a distal tip of the electrode body. The method also includes axially inserting the electrode into the torch body of the plasma arc torch and aligning the electrode relative to the torch using an axial alignment flange of the electrode while slidably engaging a current interface region of the electrode with the torch body to create an electrical conduction path between the electrode and the cathodic element. The electrical conduction path is configured to pass a plasma cutting current. The method further includes rotating the electrode relative to the torch body to engage a retention region of the electrode body with a corresponding portion of the torch body to retain the electrode within the torch body. The retention region is located at the proximal end of the torch body. In some embodiments, the aligning and the slidably engaging are substantially concurrent.

Any of the above aspects can include one or more of the following features. In some embodiments, engaging a retention region of the electrode body with a corresponding first portion of the torch body comprises rotationally engaging at least one thread or detent in the retention region of the electrode body with the corresponding first portion. In some embodiments, engaging a retention region of the electrode body with a corresponding first portion of the torch body comprises slidably engaging the retention region with the first portion.

In some embodiments, the first current conduction path is established prior to the engagement between the retention region of the electrode body and the corresponding first portion of the torch body.

In some embodiments, the current interface region of the electrode body comprises an electrically conductive pliable member circumferentially coupled to an external surface of the electrode body, the first current conduction path being established via the pliable member. In some embodiments, the pliable component comprises a spring or a Louvertac® band.

In some embodiments, a second current conduction path is established between the electrode body and the cathodic element of the torch body via physical contact established between the retention region of the electrode body and the corresponding first portion of the cathodic element of the torch body upon engagement. In some embodiments, a third current conduction path is established between the electrode body and the cathodic element of the torch body via compression of the sealing member to create physical contact between the electrode body and the torch body about the sealing member upon engagement.

In some embodiments, the method further includes flowing a liquid coolant over the current interface region of the electrode body to cool the current interface region, preventing, by the sealing member, the liquid coolant from flowing distally toward the distal tip of the electrode body, and fluidly isolating, by the sealing member, the current interface region from a plenum of the plasma arc torch. In some embodiments, at least about 24% of an axial length of the electrode is located proximal to the sealing member.

In some embodiments, axially inserting the electrode into the torch body comprises axially advancing the electrode body within the torch body until an axial stop of the electrode body physically contacts a corresponding stop within the cathodic element of the torch body to prevent further axial advancement of the electrode body. In some embodiments, an axial distance between the axial stop and the proximal end of the electrode is about 0.4 inches. In some embodiments, the engagement between the current interface region of the electrode with the cathodic element of the torch body occurs prior to the physical contact between the axial stop of the electrode body and the correspond stop within the torch body.

In yet another aspect, a method of enabling electrical conduction between an electrode and a plasma arc torch of a plasma arc cutting system is provided. The method includes providing the electrode having an electrically conductive body that defines a proximal region and a distal region. The conductive body includes at least one thread disposed at the proximal region. The method includes aligning the at least one thread of the electrode with a thread channel in an electrode holder of the plasma arc torch to achieve an aligned position, and axially inserting the electrode into the electrode holder of the plasma arc torch in the aligned position to contact an axial stop of the electrode holder, thereby establishing a first current conduction path between the electrode and the plasma arc torch via the axial stop. The method further includes radially rotating the electrode relative to the electrode holder to establish physical contact between the at least one thread of the electrode and an electrically conductive pliable member circumferentially coupled to an internal surface of the electrode holder, thereby establishing a second current conduction path between the electrode and the plasma arc torch via the electrically conductive pliable member.

In yet another aspect, a method of establishing an electrical current conduction path between an electrode and a plasma arc torch of a plasma arc cutting system is provided. The method includes aligning at least one thread of the electrode with a thread channel in an electrode holder of the plasma arc torch to achieve an aligned position and axially inserting the electrode into the electrode holder of the plasma arc torch in the aligned position. The method also includes contacting, by the electrode, an axial stop of the electrode holder to prevent further axial advance of the electrode within the electrode holder. The method further includes establishing the electrical current conduction path between the electrode and the electrode holder via a conductive pliable member as the electrode is radially rotated relative to the electrode holder and at least one thread of the electrode progressively and laterally compresses the conductive pliable member circumferentially coupled to a circumferential interior surface of the electrode holder. The progressive lateral compression of the conductive pliable member decreases electrical resistivity between the electrode and the electrode holder.

Either of the above two aspects can include one or more of the following features. In some embodiments, the axial insertion of the electrode prior to the radial rotation is performed without establishing the physical contact between the electrode and the pliable member.

In some embodiments, the radial rotation of the electrode relative to the electrode holder physically engages the electrode to the electrode holder while establishing the second current conduction path. In some embodiments, the radial rotation of the electrode relative to the electrode holder progressively compresses the pliable member to create progressively better electrical contact and progressively decreased electrical resistivity between the proximal region of the electrode and the electrode holder.

In some embodiments, the pliable member is a canted coil spring. In some embodiments, the pliable member is circumferentially coupled to the electrode holder by a retaining feature of the internal surface of the electrode holder. In some embodiments, the retaining feature comprises an elliptical channel disposed in a circumferential internal surface of the electrode holder.

In some embodiments, further axial advancement of the electrode into the electrode holder during the axial insertion is prevented when a rim in the proximal region of the electrode physically contacts the axial stop in the electrode holder. The rim can be disposed substantially circumferentially about the proximal region of the electrically conductive body of the electrode. In some embodiments, the pliable member is located proximal to the axial stop in the electrode holder. In some embodiments, the at least one thread is located proximal to the rim on the conductive body of the electrode. In some embodiments, the first current conduction path is established between electrode and the electrode holder upon physical contact between the rim of the electrode and the axial stop of the electrode holder.

In some embodiments, the plasma arc torch with the electrode inserted therein is operated at a current level greater than about 120 amps. In some embodiments, the plasma arc torch with the electrode inserted therein is operated at a current level greater than 220 amps. In some embodiments, the axial insertion of the electrode into the electrode holder establishes physical contact between the electrode and a side interior surface of the electrode holder of the plasma arc torch.

In some embodiments, a third current conduction path is established between the electrode and the plasma arc torch via physical contact between the at least one thread of the electrode and a corresponding at least one thread of the electrode holder.

In some embodiments, the axial stop is made from an electrically insulative material, in which case no current conduction path is established between the electrode and the plasma arc torch via the axial stop.

These aspects generally provide an exemplary method for securing and enabling electrical conduction between the electrode and the electrode holder. First, each of the thread regions of the electrode is radially aligned with a smooth region within the thread channel of the electrode holder. Conversely, each of the smooth regions of the electrode can be radially aligned with a thread region 130 within the thread channel of the electrode holder. The radial alignment between the components at step can be achieved in several rotational positions, relatively independent of the angle of insertion of the electrode into the thread channel of the electrode holder. Then the electrode can be axially inserted along the longitudinal direction into the thread channel of the electrode holder while being maintained in the radially aligned orientation/position. The insertion can be accomplished without any rotation. Optionally, the axial advancement stops when the rim of the electrode encounters the axial stop of the electrode holder to reach an inserted position, whereby a current conduction path can be established between the rim and the axial stop. In the inserted position, the electrode is rotated in one direction relative to the electrode holder to lock the threads of at least one thread region of the electrode with the threads of an adjacent thread region of the electrode holder in the rotational path, thereby securing the components to one another. The amount of rotation required to achieve maximum engagement at the locked position can be less than 360°. The ultimate physical engagement between the threads establishes the current conduction path. Optionally, during rotation of the electrode relative to the electrode holder, at least one thread (e.g., the proximal-most thread(s)) of the electrode progressively and laterally compresses the conductive pliable member that is circumferentially coupled to a circumferential interior surface of the electrode holder (e.g., housed within the elliptical channel), thereby establishing yet another current conduction path that is independent of the threading torque for engaging the threads.

In another aspect, a plasma arc torch is provided that includes a thread channel disposed on an interior surface of the electrode holder of the plasma arc torch, the thread channel configured to align with and receive at least one thread of an electrode. The torch also includes an axial stop located proximally relative to the thread channel in the interior surface of the plasma arc torch. The axial stop extends radially inward and is configured to physically contact a rim of the electrode to prevent further axial advancement of the electrode within the thread channel. The electrode holder further includes an elliptical channel disposed in a circumferential internal surface. The elliptical channel is configured to retain a conductive pliable member relative to the circumferential internal surface, such that the electrode is configured to establish a current conduction path with increased conductivity to the plasma arc torch as the at least one thread of the electrode is rotated into the elliptical channel progressively compressing the pliable member retained thereto.

In some embodiments, the electrode holder of the torch includes at least one thread disposed on the internal surface of the plasma arc torch adjacent to the elliptical channel. The at least one thread is configured to physically contact the at least one thread of the electrode as the electrode is rotated into the elliptical channel progressively compressing the pliable member. In some embodiments, the physical contact between the at least one thread of the electrode and the at least one thread of the electrode holder establishes an additional current conduction path between the electrode and the plasma arc torch.

In some embodiments, the physical contact between the axial stop of the plasma arc torch and the rim of the electrode establishes an additional current conduction path between the electrode and the plasma arc torch.

The plasma arc torch of this aspect can have an electrode holder that is configured to receive an electrode. The electrode holder can define a thread channel within its interior surface for aligning with and receiving the electrode. The electrode can be integrally formed with the plasma arc torch, although in some embodiments the electrode holder can be detachably connected to the plasma arc torch as a discrete consumable component. Both the electrode holder and the electrode can be constructed from one or more electrically conductive materials, such as copper.

The electrode can include at least one thread region disposed radially about the longitudinal axis on an outer surface of the electrode body near the proximal end, which is the end that encounters the electrode holder first as the electrode advances into electrode holder for engagement. Each thread region can include one or more threads. In addition, the electrode can include at least one smooth region characterized by the absence of threads or other non-regular features. Each smooth region can be disposed radially about the longitudinal axis adjacent to a thread region on the outer surface of the electrode. For example, if the electrode includes two or more thread regions and two or more smooth regions, each smooth region is circumferentially disposed between a pair of the thread regions. The electrode can include a rim disposed distal to the one or more thread regions for contacting an axial stop of the electrode holder, but the rim is not a required feature of the electrode.

For the electrode holder, the thread channel can include at least one thread region that is disposed radially about the longitudinal axis and each thread region can include one or more parallel threads. In addition, the thread channel can include one or more smooth regions characterized by the absence of threads or other non-regular features. Each smooth region can be disposed radially about the longitudinal axis adjacent to a thread region on the surface of the thread channel. The electrode holder can include an axial stop that may comprise a distal edge of a thread of the electrode holder, but the axial stop is not a required feature of the electrode. The electrode holder can further include a pliable member, such as a canted coil spring, circumferentially coupled to an internal surface of the electrode holder within the thread channel. The pliable member can be located adjacent to the thread region(s) of the electrode holder, such as immediately proximal to the thread region(s). The pliable member can be elliptically shaped when retained to the electrode holder, such as housed within an elliptical channel of the electrode holder.

In general, the thread(s) of one thread region is discontinuous from the thread(s) of an adjacent/opposing thread region for each of the electrode and the electrode holder. That is, for each of the electrode or electrode holder, the pitch of each thread does not create a continuous helical path from one thread region to the next. In addition, for each component, a thread of one thread region is physically and orientationally separate from another thread of an adjacent/opposing thread region.

In general, electrical current conduction between the electrode and the electrode holder can be established via any combination of three different paths: (i) when the rim of the electrode and the axial stop of the electrode holder physically contact each other after the electrode is axially inserted and fully seated within the thread channel of the electrode holder, (ii) from the physical engagement between the threads of the electrode and electrode holder and (iii) from the progressive lateral compression of the conductive pliable member housed in the electrode holder as the electrode engages the electrode holder. For example, establishment of any one, two or all of these paths gives rise to electrical current conduction between the electrode and the electrode holder.

It should also be understood that various aspects and embodiments of the invention can be combined in various ways. Based on the teachings of this specification, a person of ordinary skill in the art can readily determine how to combine these various embodiments. For example, in some embodiments, any of the aspects above can include one or more of the above features. One embodiment of the invention can provide all of the above features and advantages.

### BRIEF DESCRIPTION OF THE DRAWINGS

The advantages of the invention described above, together with further advantages, may be better understood by referring to the following description taken in conjunction with the accompanying drawings. The drawings are not necessarily to scale, emphasis instead generally being placed upon illustrating the principles of the invention.

FIGS. 1A-C show side, rear perspective, and front perspective views, respectively, of an exemplary electrode, according to some embodiments of the present invention.

FIG. 2 shows an exemplary plasma arc torch with the electrode of FIG. 1 disposed within a torch body, according to some embodiments of the present invention.

FIG. 3 shows another exemplary electrode with three sealing members, according to some embodiments of the present invention.

FIG. 4 shows an exemplary plasma arc torch with the electrode of FIG. 3 disposed within a torch body, according to some embodiments of the present invention.

FIG. 5 shows another exemplary electrode with an absence of any thread features, according to some embodiments of the present invention.

FIG. 6 shows an exemplary plasma arc torch having at least one retention feature for retaining the electrode of FIGS. 1A-C within the torch, according to some embodiments of the present invention.

FIG. 7 shows an exemplary process for enabling electrical conduction and engagement between an electrode and a plasma arc torch, according to some embodiments of the present invention.

FIG. 8 illustrates another exemplary plasma arc torch comprising an electrode holder configured to receive an electrode, according to some embodiments of the present invention.

FIG. 9 illustrates an exemplary configuration of the electrode of the plasma arc torch of FIG. 8, according to some embodiments of the present invention.

FIG. 10 illustrates an exemplary configuration of the electrode holder of the plasma arc torch of FIG. 8, according to some embodiments of the present invention.

FIGS. 11A and 11B illustrate top sectional views of the relative positions of the threads of the electrode with respect to the pliable member within the thread channel of the electrode holder of FIG. 8 prior to rotation and after rotation, respectively, according to some embodiments of the present invention.

FIG. 12 illustrates an exemplary method for securing and enabling electrical conduction between the electrode and the electrode holder of the plasma arc torch of FIG. 8, according to some embodiments of the present invention.

FIG. 13 shows an adapter portion of another exemplary electrode, according to some embodiments of the present invention.

### DETAILED DESCRIPTION

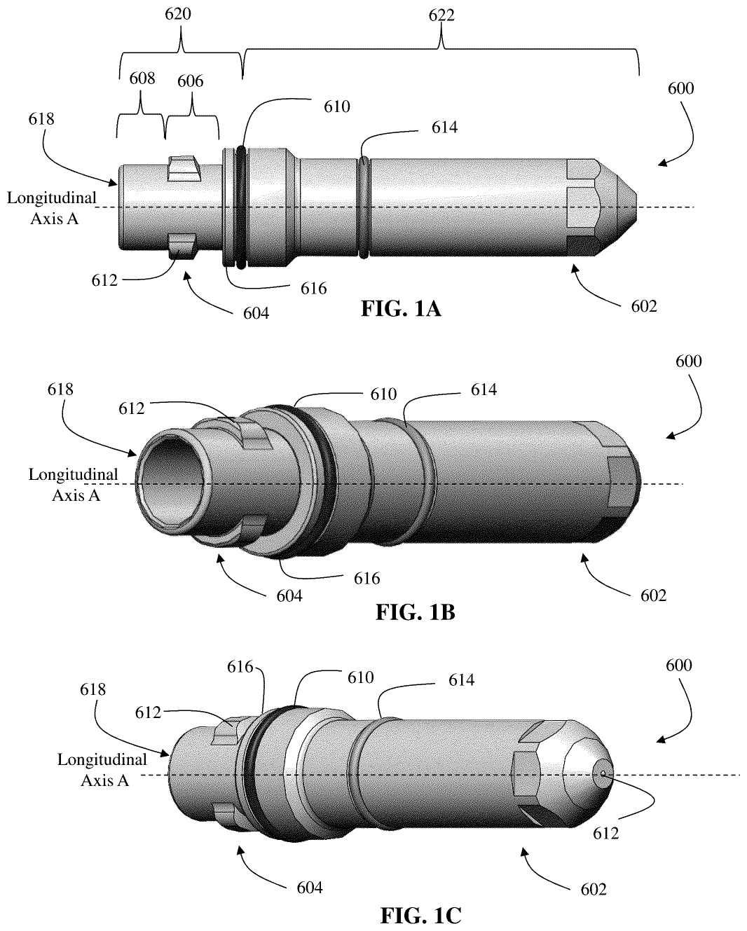

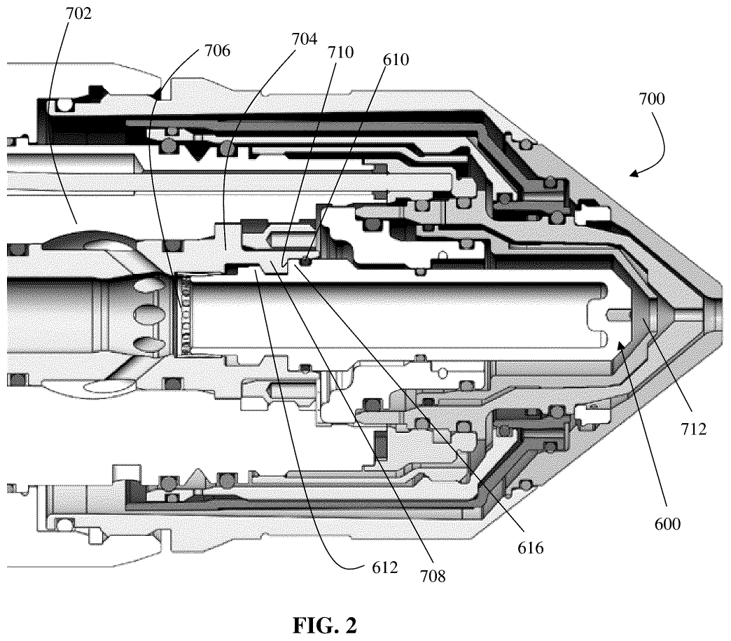

FIGS. 1A-C show side, rear perspective, and front perspective views, respectively, of an exemplary electrode 600, according to some embodiments of the present invention. FIG. 2 shows an exemplary plasma arc torch 700 with the electrode 600 of FIG. 1 disposed within a torch body 702, according to some embodiments of the present invention. At least a portion of the plasma arc torch 700 may be liquid cooled. As shown in FIGS. 1A-C, the electrode 600 generally comprises an elongated electrode body extending along a central longitudinal axis A and is substantially symmetrical about a central longitudinal axis A. In addition, the electrode 600 has a distal end 602, which is defined as the end that is closet to a workpiece when installed in the torch 700 and used to process the workpiece, and a proximal end 604, which is defined as the end opposite of the distal end 602 along longitudinal axis A. The distal end 602 of the electrode 600 can include at least one emissive insert 612 disposed therein. The proximal end 604 of the electrode 600 can include a retention region 606 shaped to engage a portion of the torch body 702 for retaining the electrode within the torch body 702. In some embodiments, a current interface region 608 is located on the electrode 600 axially proximal to the retention region 606 along longitudinal axis A. The current interface region 608 is configured to slidably engage another portion of the torch body 702 while electrically communicating with a cathodic element 704 of the plasma arc torch 700. In some embodiments, the electrode 600 further includes at least one sealing member 610, such as an O-ring, circumferentially disposed about the electrode body 600. The sealing member 610 can be located on the electrode body axially distal to both the current interface region 608 and the retention region 606.

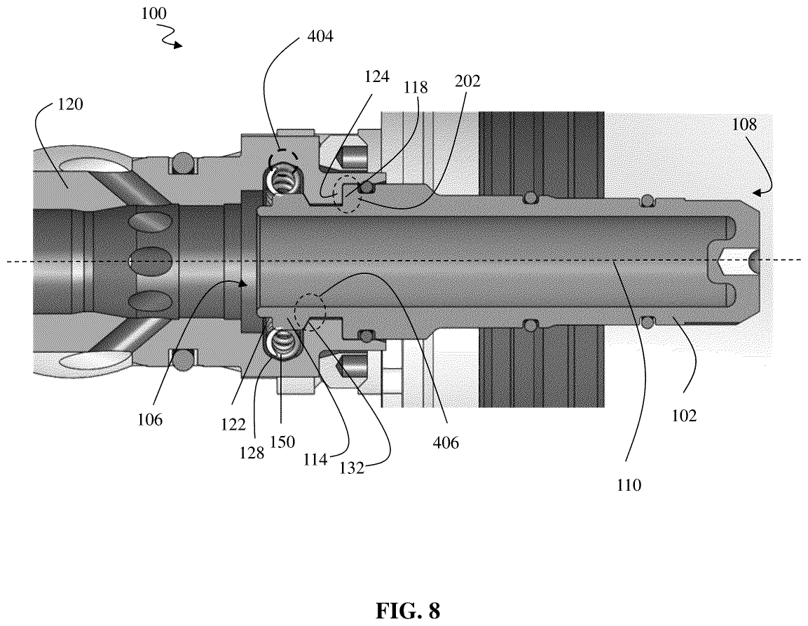

As shown, the current interface region 608 is proximal to (i.e., rearward of) both the retention region 606 and the sealing member 610. In some embodiments, the axial length of the current interface region 608 is between about 5% and about 40% of the entire axial length of the electrode 600. In some embodiments, the axial length of the current interface region 608 is between about 7% and about 30% of the entire axial length of the electrode 600, such as between about 10% and about 20%. The current interface region 608 can comprise an electrically conductive, circumferential surface on an extended portion at the proximal end 604 of the electrode 600. This extended electrical contact surface of the current interface region 608 can conductively engage a current conduction component (e.g., the cathodic element 704) within the plasma arch torch 700. For example, as shown in FIG. 2, the electrical contact surface of the current interface region 608 can be configured to conductively engage a pliable component 706 (e.g., a coil spring, clip contact, Louvertac® band, etc.) that is disposed about the current interface region 608 within the torch body 702, through which the current interface region 608 can electrically communicate with the cathodic element 704 while matingly engaging the torch body 702. In some embodiment, the cathodic element 704 of the plasma arc torch 700 functions as an electrode holder for holding/engaging the electrode 600 once it is installed within the torch body, substantially the same/similar to electrode holder 102 of FIG. 8 described below. In some embodiments, the pliable component 706 is electrically conductive. In some embodiments the pliable component 706 is plated, such as with gold and/or silver. In some embodiments, the pliable component 706 has an axial length of between about 0.16 inches and about 0.20 inches and is disposed within an inner bore of the plasma arc torch 700.

Once the electrode 600 is disposed within the torch body 702 of the plasma arc torch 700, a substantial portion of the proximal end 604 of the electrode 600 (i.e., the current interface region 608 of the electrode 600) extends partially within or through the pliable component 706 in the torch 700. A dynamic interference fit can form between the inner diameter of the pliable component 706 and the outer contact surface of the current interface region 608 of the electrode 600. The radially compressive/compliant nature of the pliable component 706 and the complementary design shape of the electrical contact surface of the current interface region 608 can account for and accommodate various material and/or manufacturing variations as well as compensate for incomplete installation of the electrode 600 to the torch body 702 to insure that a proper electrical contact interface is established between the electrode 600 and the torch 700 upon insertion of the electrode 600 within the torch body 702. For example, the pliable component 706 and/or the current interface region 608 can be suitably shaped to conductively engage each other. In some embodiments, the inner diameter (ID) of the torch 700, such as the ID of the pliable component 706, is smaller than the outer diameter (OD) of the current interface region 608 of the electrode 600. In some embodiments, the interference range (i.e., the difference between ID and OD) is greater than 0, such as between about 0.007 inches and about 0.021 inches. Such an ID-OD relationship, combined with the flexible nature of the pliable component 706, enables reliable electrical connection between the torch 700 and the electrode 600 that is independent of any requirement of user-applied torque when installing the electrode 600 into the torch body 702.

As described above, the pliable component 706 can be a canted coil or a Louvertac® band designed with multiple contact points with the electrode 600 to ensure high current carrying capability. In some embodiments, the pliable component 706 comprises a clip contact ring, which is a spring-grade, electrically conductive, circular cross-sectioned wire that is formed into an oval shape with an opening on the long side to provide flexibility for installation into a groove (not shown) in the torch body 704 and promote physical contact with the electrode 600 once the electrode is inside of the torch 700. The height of the clip can be sized so that the open end and opposing side are tight on the outer diameter of the groove to enhance maintenance of electrical contact. The clip contact's large cross-sectional area (relative to the torch body groove size) and oval geometry enables the clip contact to achieve (i) optimal retention in the torch body groove, (ii) excellent resilience to twisting, especially when the electrode 600 changes the direction of rotation in threaded applications, (iii) good flexibility resulting in low drag on the cathodic element, and (iii) guarantee of multiple, such as at least two, points of contact at all times with the cathodic element 704. In some embodiments, the clip contact has a helical shape to assist in its installation into the torch body groove and provide an additional point (or two) of contact with the groove. In some embodiments, the clip contact is tailored to operate in conjunction with the threads 612 in the retention region 606 of electrode 600, such as relying on the threads 612 to function as the primary current carrying path.

In general, the current interface region 608 at the proximal end 604 of the electrode 600 is configured to promote dynamic and flexible physical connection (e.g., interference fit) with the pliable component 702 during both installation and removal, thereby creating a robust conduction interface for an operating current to flow from the torch 700 to the electrode 600 during torch operation and ultimately to the distal end 602 of the electrode 600 to enable material processing. In some embodiments, as shown in FIG. 2, the current interface region 608 of the electrode 600 can be shaped to have a slight bevel, which increases the wall thickness of the electrode 600 from the proximal end 604 toward the distal end 602 along the surface of the current interface region 608. The resulting increased surface area in contact/interface between the pliable component 706 and the current interface region 608 of the electrode 600 is adapted to promote current conduction, eliminate arcing and current concentrations across the interface, and/or help to secure the electrode 600 to the plasma arc torch 700. In some embodiments, as illustrated in FIG. 1B, the proximal tip 618 of the current interface region 608 of the electrode 600 includes an end feature, such as a slightly narrower radius or a slight chamfer, etc., shaped to facilitate proper mating/seating between the current interface region 608 and the pliable component 706 during installation. In some embodiments, the proximal tip 618 of the of the current interface region 608 of the electrode 600 can comprise any number of features, including grooves, convex profiling, concave profiling, etc., to promote electrical conduction and/or retention between the electrode 600 and the torch body 702. In some embodiments, the current interface region 608 of the electrode 600 has a non-circular cross section, but still maintains a maximum-inscribed, circular cross-sectional portion (e.g., a diameter in at least one location of the current interface region 600) to form an interference fit with the pliable component 706. For example, the current interface region 608 can be hexagonal in cross-sectional shape with peaks of the hexagon configured to contact and form an interference fit with the pliable component 706.

While the instant application describes the electrical contact surface of the current interface region 608 being formed on a circumference of an electrode and the pliable component 706 coupled to an internal surface of a plasma arc torch, variations of this design are also within the scope of the present invention. For example, the pliable component 706 can be coupled to the electrode (e.g., permanently installed upon the electrode) and the current interface region 608 can be formed on the mating portion of the plasma arc torch, thereby establishing substantially the same robust retention and current conduction interface. In some embodiments, the robust interface created between the current interface region 608 of the electrode 600 and the pliable component 706 in the torch body 702 enables direct liquid cooling of these elements to reduce thermal degradation of these elements over time, which will be explained below in detail.

In some embodiments, the retention region 606 of the electrode 600 comprises about 11% the overall axial length of the electrode 600. For example, the ratio of the axial extent of the retention region 606 to the axial extent of the current interface region 608 can be about 1:1. The retention region 606 can include at least one thread 612 or detent (not shown) configured to engage a complementary feature of the torch body 702, such as a complementary thread 708 or detent (not shown), for the purpose of physically securing the electrode 600 to the torch body 702. In some embodiments, the threads 612 of the electrode 600 (as well as the threads 708 of the torch body 702) can be discontinuous, such as the discontinuous threads described in U.S. patent application Ser. No. 15/904,871, which is owned by the assignee of the instant application and is incorporated herein by reference in its entirety.

In some embodiments, engagement between the electrode 600 and the torch body 702 via physical connection between the thread(s) 612 (or detent) of the retention region 606 and the corresponding feature 708 of the torch body 702 creates another interface through which electrical current can be conducted between the electrode 600 and the torch body 702. This current interface via the engagement region 606 can be in addition to or in place of the current conduction path created between the current interface region 608 of the electrode 600 and the pliable component 706 of the torch body 702 described above. In some embodiments, the retention region 606 of the electrode 600 further includes an axial stop 616 disposed axially distal relative to the thread(s) 612 (or detent). For example, the axial distance between the axial stop 616 and the proximal tip 618 of the electrode 600 can be about 0.4 inches. The axial stop 616 of electrode 600 is configured to physically contact a rim 710 of the torch body 702 during installation of the electrode 600 within the torch body 702. More specifically, during installation, the electrode 600 axially advances within the torch body 702 in the proximal direction until the axial stop 616 physically contacts the rim 710 to prevent further axial advancement of the electrode 600, at which position the electrode 600 can be rotated within the torch body 702 to securely engage the thread(s) 612 in the retention region 606 of the electrode 600 with the thread(s) 708 in the torch body 702.

In some embodiments, upon achieving the secure engagement between the electrode 600 and the torch body 702, the sealing member 610 is adapted to be compressed to allow physical contact between the torch body 702 and the electrode 600 about the sealing member 610, thereby creating yet another current interface between the electrode 600 and the torch body 702. This current interface can be in addition to or in place of (i) the current interface created between the retention region 606 of the electrode 600 and its corresponding portion of the torch body 702 and/or (ii) the current interface created between the current interface region 608 of the electrode 600 and the corresponding torch body portion. In some embodiments, the sealing member 610 can be disposed around the electrode 600 at its widest diameter. In some embodiments, at least about 22% of the overall axial length of the electrode 600 is located proximal to the sealing member 610.

During torch operation, the sealing member 610 is configured to fluidly isolate the current interface region 608 from a plenum 712 of the plasma arc torch 700. More specifically, a proximal portion 620 of the electrode 600 relative to the sealing member 610, which includes the current interface region 606 and the retention region 608, is fluidly isolated from a distal portion 622 of the electrode 600 relative to the sealing member 610. This distal portion 622 of the electrode 600 is configured to direct one or more gas or liquid flows about the plasma arc torch 700 that are sealed and isolated from the proximal portion 620. In some embodiments, the external surface of the proximal portion 620 of the electrode 600, which includes the current interface region 606 and the retention region 608, is cooled by a liquid coolant. This can axially extend about 22% of the entire axial length of the electrode 600. In some embodiments, the internal surface of the distal portion 622 of the electrode 600 is liquid cooled. This can axially extend about 95% of the entire axial length of the electrode 600. In some embodiments, the external surface of the distal portion 622 of the electrode 600 is gas cooled. This can axially extend about 78% of the entire axial length of the electrode 600.

In some embodiments, as shown in FIGS. 1A-C, a second sealing member 614 is circumferentially disposed about an external surface of the electrode 600, such as distal to the first sealing member 610. Even though FIGS. 1A-C illustrate that two sealing members 610, 614 are coupled to the electrode 600, in alternative embodiments, the electrode 600 can have fewer (e.g., 1) sealing member or more sealing members (e.g., 3 or 4).

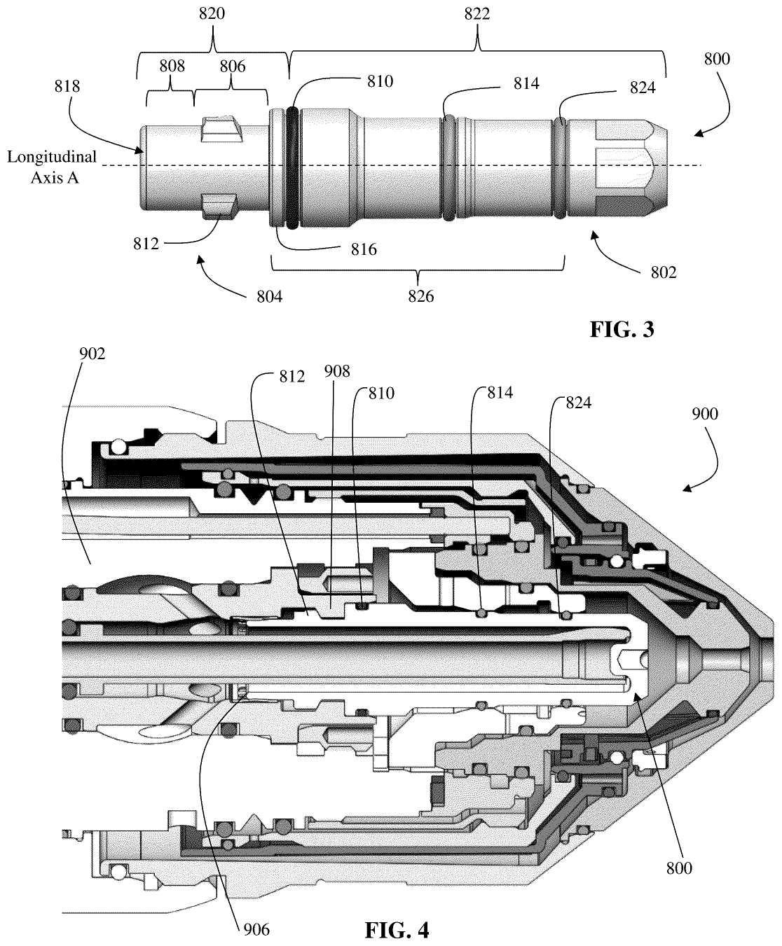

In some embodiments, the electrode 600 can include three or more sealing members. FIG. 3 shows another exemplary electrode 800 with three sealing members 810, 814, 824, according to some embodiments of the present invention. Except for the additional sealing member 820, the electrode 800 can be substantially the same as the electrode 600 depicted in FIGS. 1A-C, including the same current interface region 806, retention region 808 and two sealing members 810, 814. The additional third sealing member 824 can be located distal to both the first and second sealing members 810, 814. As shown, the current interface region 808 of electrode 800 is formed axially proximal to the retention region 806 (including threads 812) as well as the three sealing members 810, 814, 824. In general, strategic addition and placement of sealing members at the distal portion of an electrode can be used to support different gas flow patterns around the distal portion. For example, usages of two or three sealing members can help segment and guide gas flows in various directions, such radially and/or axially relative to the electrode. In some embodiments, the distance 826 between the axial stop 816 of the electrode 800 and the third sealing member 824 is between about 0.4 inches and about 0.5 inches.

FIG. 4 shows an exemplary plasma arc torch 900 with the electrode 800 of FIG. 3 disposed within a torch body 902, according to some embodiments of the present invention. The electrode 800 with the three sealing members 810, 814, 824 is retained within the torch body 902 via engagement between the thread(s) 812 disposed in the retention region 806 of the electrode 800 and the corresponding threads 908 in the torch body 902. Electrical conduction/connection between the electrode 800 and the torch body 902 can be made through at least one of several means: (i) via the threaded engagement between the two components, (ii) via physical contact between the electrical conduction region 808 of the electrode 800 and the pliable component 906 in the torch body 902, and/or (iii) via the physical interfaces about the sealing members 810, 814, 824, where the sealing members are compressed to enable physical contact between the electrode 800 and the torch body 902 in those regions. In some embodiments, the physical interface between the electrical conduction region 808 of the electrode 800 and the pliable component 906 in the torch body 902 is directly cooled by a liquid coolant from the plasma arc torch system. In some embodiments, the coolant flows through and/or around the pliable component 906 as well as at the interface between the pliable component 906 and the electrical conduction region 808 of the electrode 800.

In some embodiments of the electrodes of the present invention (e.g., electrode 600 of FIGS. 1A-C and/or electrode 800 of FIG. 3), primary electrical conduction between the electrode and the torch body is via the thread(s) or detent in the retention region of each electrode and the corresponding feature(s) in the torch body, while the interface between the current interface region of the electrode and the pliable component provides an alternative anti-arcing conduction path. In some embodiments, the interface between the electrical conduction region of each electrode and the pliable component provides the primary electrical conduction path for an operating current to travel between the torch body and the electrode, such as the sole conduction path. Yet in some embodiments, both paths provide about similar levels of current conduction between the torch body and the electrode.

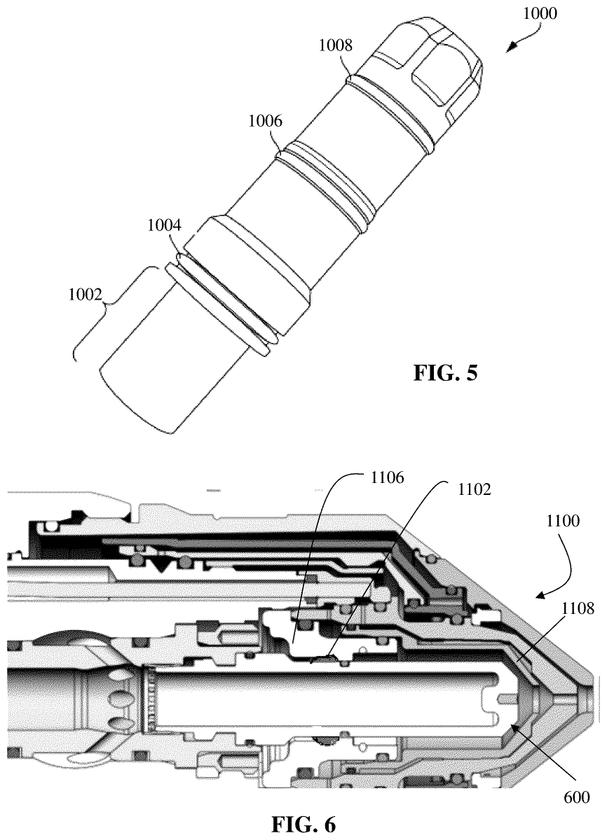

In some embodiments, the electrodes of the present invention (e.g., electrode 600 of FIGS. 1A-C and/or electrode 800 of FIG. 3) do not have any threads in the retention region 606 and instead have a smooth surface in the retention region. Alternatively, the electrodes can have continuous threads or discontinuous threads in the retention region for engagement with the torch body. Regardless of whether threads are present in the retention region of an electrode, the electrode can still provide current conduction with the torch body via the interface established between its current conduction region and the pliable component and/or via the interface(s) established about its one or more sealing members. FIG. 5 shows another exemplary electrode 1000 with an absence of any thread features, according to some embodiments of the present invention. As shown, the electrode 1000 is substantially the same as the electrode 800 of FIG. 3, with the exception that thread(s) 812 of the electrode 800 of FIG. 3 are absent from the electrode 1000 of FIG. 5. Instead, the current interface region 1002 of the electrode 1000 can be configured to provide both current conduction and engagement functions, thereby eliminating the need for threads or other protruding rigid retention structures on the electrode 1000. For example, the current interface region 1002 can physically engage a corresponding portion of the torch body, such as the pliable component 706 disposed within the torch body, via interference fit when installed inside of a plasma arc torch. In some embodiments, the current interface region 1002 is shaped with a slightly narrower radius and/or other features described above to facilitate physical contact and interference fit with the pliable component 706 once the electrode 900 is inserted within the torch body. Such engagement is sufficient to securely retain the electrode 1000 within a plasma arc torch.

FIG. 13 shows an adapter portion 1300 of another exemplary electrode, according to some embodiments of the present invention. As shown, the electrode adapter portion 1300 comprises a distal end 1302 (which is the end closest to the workpiece during torch operation) and a proximal end 1304 (which is the end opposite of the distal end 1302). The proximal end 1304 of the electrode adapter portion 1300 includes a first retention region 1306 having at least one rigid retention protrusion 1306 shaped to matingly engage a complementary retention feature in the plasma arc torch (e.g., on the cathodic element 704 of the plasma arc torch 700 of FIG. 2 or the electrode holder 120 of the plasma arc torch 100 of FIG. 8 described below). The proximal end 1304 of the adapter portion 1300 is configured to be inserted within the torch and engage the torch via the first retention region 1306. In some embodiments, the distal end 1302 of the electrode adapter portion 1300 includes a second retention region 1316 configured to connect to a second electrode portion (not shown). The second retention region 1316 can include one or more traditional continuous threads 1317 to connect to the second electrode portion. The electrode adapter portion 1300 and the second electrode portion can form a complete electrode. In some embodiments, the second electrode portion is shorter and can include complementary threaded mating features configured to connect to the adapter portion 1300 via the second retention region 1316 during installation. In some embodiments, the electrode adapter portion 1300 is hollow to allow coolant to flow therethrough to the distal end 1302 (via a coolant tube) and out of a distal aperture 1309 located at the distal end 1302 and back into the torch.

In some embodiments, there are multiple distinct rigid retention protrusions 1306 disposed circumferentially about the proximal end 1304 of the electrode adapter portion 1300. In some embodiments, each rigid retention protrusion 1306 of the electrode adapter portion 1300 is adjacent to at least one smooth region 1310 (e.g., an axial slot). For example, each rigid retention protrusion 1306 can be sandwiched between a pair of the smooth regions 1310. Each smooth region 1310 is configured to allow rigid retention protrusions 1306 of the electrode adapter portion 1300 to axially pass at least a portion of the complementary rigid retention protrusions in the plasma arc torch. The electrode adapter portion 1300 may slide into the plasma arc torch until the rigid retention protrusion 1306 is aligned with the complementary rigid retention protrusions (such as a male thread) in the plasma arc torch. An axial stop 1312 of the electrode adapter portion 1300 may physically encounter a corresponding rim in the torch to establish this alignment. After such a physical contact is made, the electrode adapter portion 1300 and/or the torch can be rotated relative to one another such that complementary rigid retention protrusions on each of the electrode adapter portion 1300 and the torch (e.g., on a cathodic element/electrode holder of the torch) engage each other to fixedly connect the electrode adapter portion 1300 to the plasma arc torch. In some embodiments each rigid retention protrusion 1306 has carved out a channel 1314 for matingly receiving a complementary retention feature of the torch (e.g., a protrusion on an interior surface of the torch configured to form a tight fit within the channel 1314). The channel 1314 in a rigid retention protrusion 1306 creates a C shaped raised portion 1307 on the surface of the electrode adapter portion 1300. In some embodiments, two or more C shaped raised portions 1307 may be located on opposing radial sides of the electrode adapter portion 1300. In some embodiments, each channel 1314 is normal to the orientation of the torch retention features. In alternative embodiments, each channel 1314 is angled relative to the torch retention features. In some embodiments, each channel 1314 narrows across its radial distance such that as a torch retention feature is rotated into the channel 1314 the torch retention feature is progressively squeezed/secured. In some embodiments, after the electrode adapter portion 1300 is secured to the torch via the first retention region 1306, the second electrode portion is secured to the electrode adapter portion 1300 via the second retention region 1316. Alternatively, the second electrode portion can be first secured to the electrode adapter portion 1300 to form a complete electrode prior to the combination of which being secured to the torch.

In some embodiments, the electrode adapter portion 1300 has a current interface region 1308 extending from its proximal end 1304 and proximal to the retention region 1306 along longitudinal axis A. The current interface region 1308 is configured to slidably engage another portion of the torch body while electrically communicating with a cathodic element/electrode holder, such as is shown in item 704 in FIG. 2 of the plasma arc torch 700. In some embodiments, the electrode adapter portion 1300 further includes at least one sealing member 1315, such as an O-ring, circumferentially disposed about the adapter portion 1300. The sealing member 1315 can be located on the adapter body axially distal to both the current interface region 1308 and the retention region 1306.

In general, the sealing member(s) of the electrodes of the present invention (e.g., electrode 600 of FIGS. 1A-C, electrode 800 of FIG. 3, electrode 1000 of FIG. 5 and the composite electrode described with reference to FIG. 13) are designed to complement the current interface region of each electrode to further axially retain/secure the electrode within the plasma arc torch. In some embodiments, the current interface region and the sealing member(s) of an electrode are not responsible for nor involved in the spacing and location of the electrode within the plasma arc torch. More specifically, the retention and current conduction capabilities provided by the current interface region and the sealing member(s) of the electrode are separable from the axial location/spacing of the electrode relative to the nozzle of the plasma arc torch.

In some embodiments, one or more retention features, in addition to or in place of the retention region of an electrode, are provided to assist in locating, orienting and/or retaining an electrode within a plasma arc torch relative to one or more consumables in the torch. FIG. 6 shows an exemplary plasma arc torch 1100 having at least one retention feature 1102 for retaining the electrode 600 of FIGS. 1A-C within the torch 1100, according to some embodiments of the present invention. Even though FIG. 6 is illustrated in relation to the electrode 600 of FIGS. 1A-C, any one of the electrode 800 of FIG. 3 and electrode 1000 of FIG. 5 can also be suitably configured for installation within the torch 1100. As shown, the retention feature 1102 can be one or more nubs formed about a circumference of the electrode 600. The one or more nubs 1102 can be configured to abut against a swirl ring 1106 of the torch 1100, thereby locating, orienting, and holding in place the electrode 600 relative to the swirl ring 1106. In alternative embodiments, the retaining feature 1102 is located more distally on the electrode 600 to physically interface with the nozzle 1108. In some embodiments, the retaining feature 1102 also provides location/spacing function for the electrode 600 to ensure that the electrode 600 is suitably spaced relative to other torch components upon installation into the torch 1100.

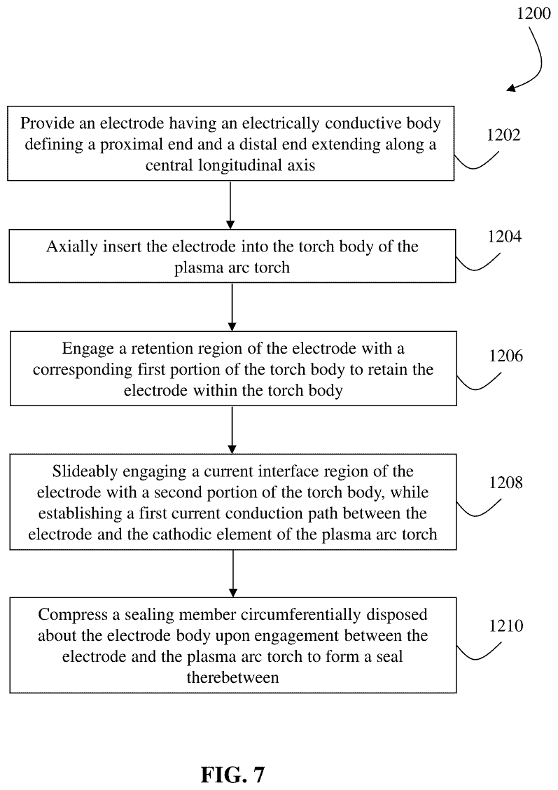

FIG. 7 shows an exemplary process 1200 for enabling electrical conduction and engagement between an electrode and a plasma arc torch, according to some embodiments of the present invention. At step 1202, an electrode is provided, which can be any one of electrode 600 of FIGS. 1A-C, electrode 800 of FIG. 3, electrode 1000 of FIG. 5 or the composite electrode described above with reference to FIG. 13. At step 1204, the electrode is axially inserted into the torch body of a plasma arc torch, which can be any one of torch 700 of FIG. 2, torch 900 of FIG. 4, or torch 1100 of FIG. 6, for the purpose of installing the electrode within the torch. In some embodiments, during insertion, the axial advancement of the electrode into the torch body only ceases when an axial stop of the electrode (e.g., axial stop 616 of electrode 600) physically contacts a corresponding rim of the torch (e.g., rim 610 of torch 700) that prevents further axial advancement by the electrode. Thus, the axial stop and rim combination serves to axially locate the electrode within the torch. Thereafter, the electrode can be secured to the torch by physically engaging the retention region of the electrode to a corresponding portion of the torch body. For example, threads 612 (or a detent) on retention region 606 of the electrode 600 can be rotationally engaged to threads 706 (or a corresponding detent) of the torch body 702 of torch 700 to secure these components relative to each other. Alternatively, in the absence of threads or other protruding feature(s) in the retention region, such as for the electrode 1000 of FIG. 5, the electrode can be secured to the torch body by slidably engaging the proximal end of the electrode (e.g., the current interface region 1002 of electrode 1000) with the corresponding portion of the torch body via interference fit.

At step 1206, the current interface region of the electrode (e.g., current interface region 608 of electrode 600), which is axially proximal to the retention region of the electrode (e.g., retention region 606 of electrode 600), is slidably engaged to another corresponding portion (e.g., the pliable component 706) of the torch body to establish a current conduction path between the electrode and the torch. In some embodiments, the electrode is aligned relative to the torch using an axial alignment flange of the electrode (e.g. axial stop 616 of electrode 600) while the current interface region of the electrode is being slidably engaged to the corresponding portion of the torch body (e.g. rim 710 of torch 700). The aligning and sliding motions can be substantially concurrent such that the axial advancement of the electrode within the torch is guided by the axial alignment flange.

In some embodiments, the resulting current conduction path between the current interface region of the electrode and the corresponding portion of the torch body is established prior to the secured engagement between the retention region of the electrode and the corresponding portion of the torch body at step 1204. For example, with respect to FIG. 2, current conduction between the electrode 600 and the torch body 702 can occur as soon as the current interface region 608 slides through the pliable component 706, but prior to the threads 612 of the electrode 600 and the corresponding threads 708 of the torch body 702 being rotated relative to each other to secure the components together, and in some embodiments, even prior to the axial stop 616 of the electrode 600 contacting the rim 710 of the torch 700 during insertion of the electrode 600 into the torch 700. In addition, a second current conduction path between the electrode 600 and the torch body 702 can be established upon physical contact and engagement between the retention region 606 of the electrode 600 and the corresponding portion of the torch body 702 (e.g., via threaded connection or interference fit). In some embodiments, the second current conduction path is established after establishing the first current conduction path between the current conduction region 608 of the electrode 600 and the pliable component 706 of the torch body 702.

At step 1208, once the electrode is seated within the torch body, at least one sealing member that is circumferentially disposed about the electrode is compressed against the torch body or another consumable within the torch to form a seal therebetween. In general, the electrode can have one or more sealing members, such as two sealing members 610, 614 for the electrode 600 of FIGS. 1A-C or three sealing members 810, 814 and 824 for the electrode 800 of FIG. 3. As explained above, the sealing member(s) can be located axially distal to the current interface region and the retention region of the electrode. In some embodiments, additional current conduction path(s) between the electrode and the torch are established upon compression of the sealing member(s) of the electrode to create physical contact between the electrode and the corresponding consumable of the torch at an interface about each sealing member. Therefore, the electrode designs of the present invention are configured to support multiple current conduction paths between an electrode and a plasma arc torch.

In some embodiments, the process 1200 of FIG. 7 can further include flowing a liquid coolant through the electrode, the pliable component, and/or the interface therebetween to cool the interface between the current interface region of the electrode (e.g., current interface region 608 of electrode 600) and the pliable component of the torch (e.g., pliable component 706 of torch 700) once the electrode is installed within the torch. Each of the sealing member(s) of the electrode (e.g., sealing members 610, 614) is adapted to form a liquid-impermeable seal with the corresponding torch consumable to substantially prevent the liquid coolant and/or gases from flowing distally toward the distal tip of the electrode. Thus, the sealing member(s) of the electrode can fluidly isolate the current interface region from the plenum of the torch (e.g., plenum 712 of torch 700 of FIG. 2). In general, features at the proximal portion of the electrode are configured to mainly provide electrical current conduction with the torch while features at the distal portion of the electrode are configured to mainly seal and isolate liquid and/or gas flows.

In another aspect, the present invention features an electrode holder of a torch body of a plasma arc torch that provides multiple conductive paths for electrical energy transfer between an electrode and the torch body. FIG. 8 illustrates an exemplary plasma arc torch 100 comprising an electrode holder 120 configured to receive an electrode 102, according to some embodiments of the present invention. In general, the electrode holder 120 defines a thread channel 122 within its interior surface for aligning with and receiving the electrode 102. In some embodiments, the electrode holder 120 is integrally formed with the plasma arc torch 100. Alternatively, the electrode holder 120 is detachably connected to the torch 100 as a discrete consumable component. In some embodiments, both the electrode holder 120 and the electrode 102 are constructed from one or more electrically conductive materials. In the context of the present invention, “distal” generally refers to an end of a torch component disposed along a longitudinal axis 110 of the torch 100 that is closest to a workpiece (not shown) when the component is assembled in the torch 100 and positioned to process the workpiece, and “proximal” generally refers to an end of the torch component that is opposite from the distal end along the longitudinal axis 110.

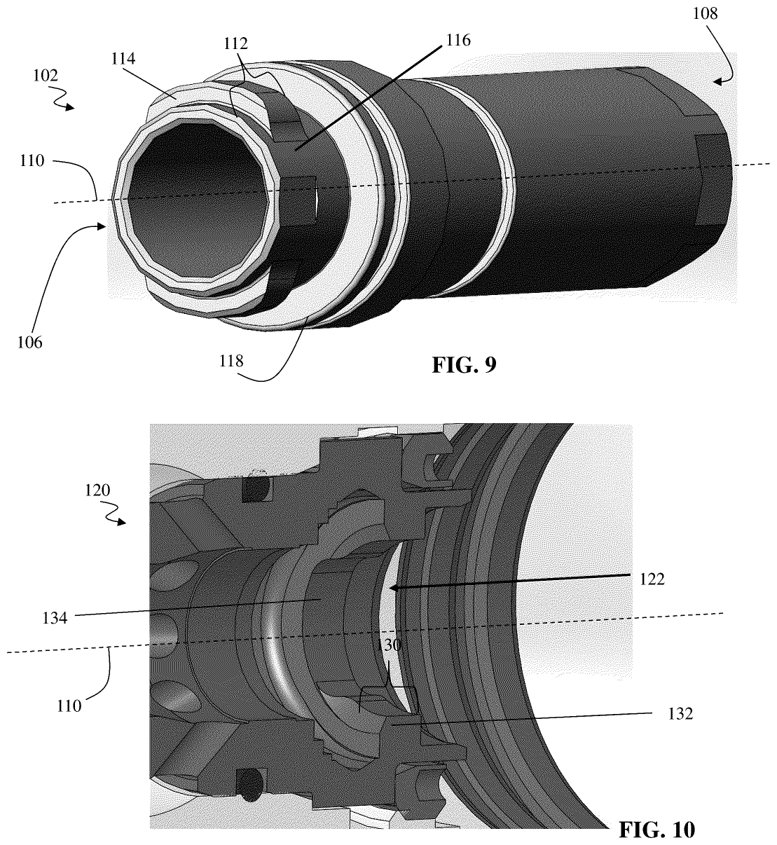

FIG. 9 illustrates an exemplary configuration of the electrode 102 of the plasma arc torch 100 of FIG. 8, according to some embodiments of the present invention. As shown, the electrode 102 includes an electrically conductive body having a proximal end 106 and a distal end 108 disposed along the longitudinal axis 110. The proximal end 106 of the electrode 102 can be characterized as the end that encounters the electrode holder 120 first as the electrode 102 advances into electrode holder 120 for engagement. The distal end 108 is disposed opposite of the proximal end 106 along the longitudinal axis 110. At least one thread region 112 is disposed radially about the longitudinal axis 110 on an outer surface of the electrode body near the proximal end 106. Each thread region 112 includes one or more threads 114 disposed on the outer surface of the electrode body 104. In some embodiments, the one or more threads 114 are evenly spaced relative to each other. The one or more threads 114 of each thread region 112 can be substantially orthogonal to the longitudinal axis 110 or helical about the longitudinal axis 110. In addition, the electrode 102 includes at least one smooth region 116 characterized by the absence of threads or other non-regular features. Each smooth region 116 is disposed radially about the longitudinal axis 110 adjacent to a thread region 112 on the outer surface of the electrode 102. In some embodiments, the electrode 102 includes two or more thread regions 112 and two or more smooth regions 116, where each smooth region 116 is circumferentially disposed between a pair of the thread regions 112. Exemplary configurations of such engagement features for an electrode are provided in U.S. patent application Ser. No. 16/988,092, which is owned by the assignee of the present application and is incorporated by reference in its entirety. Alternatively, the electrode 102 can include traditional continuous threads as the engagement feature. In some embodiments, a rim 118 is disposed substantially circumferentially about the proximal region 106 on the electrically conductive body of the electrode 102. The one or more thread regions 112 can be located proximal to the rim 118 on the conductive body of the electrode 102. The rim 118 is configured to physically contact an axial stop 124 of the electrode holder 120 to prevent further axial advancement of electrode 102 within the electrode holder 120 once a desired axial position is reached. Details regarding the interaction between the rim 118 and the axial stop 124 will be described below.

FIG. 10 illustrates an exemplary configuration of the electrode holder 120 of the plasma arc torch 100 of FIG. 8, according to some embodiments of the present invention. As shown, an interior surface of the electrode holder 120 defines the thread channel 122 that is configured to align with and receive the electrode 102. The thread channel 122 includes at least one thread region 130 that is disposed radially about the longitudinal axis 110 on a surface of the thread channel 122, and each thread region 130 can include one or more parallel threads 132. In some embodiments, these threads 132 are evenly spaced relatively to each other. In some embodiments, these threads 132 are substantially orthogonal to or helical about the longitudinal axis 110. In addition, the thread channel 122 includes one or more smooth regions 134 characterized by the absence of threads or other non-regular features. Each smooth region 134 is disposed radially about the longitudinal axis 110 adjacent to a thread region 130 on the surface of the thread channel 122. In general, the electrode holder 120 includes complementary thread/smooth features to those of the electrode 102 to facilitate the secure engagement of the two components. For example, the numbers of thread regions, threads per thread region, and smooth regions can be the same for the electrode 102 and the electrode holder 120.

In some embodiments, each smooth region 134 of the thread channel 122 is appropriately dimensioned such that it functions as a slot for aligning with and receiving a thread region 112 of the electrode 102. The radial extent of the smooth region 134 can be substantially the same as the radial extent of the thread region 112. Conversely, each smooth region 116 of the electrode 102 is appropriately dimensioned such that it functions as a slot for aligning with and receiving a thread region 130 on the thread channel 122 of the electrode holder 120. The radial extent of the smooth region 116 can be substantially the same as the radial extent of the thread region 130. The smooth regions 116 of the electrode 102 and the smooth regions 134 of the electrode holder 120 can guide the slidable displacement of one component in relation to the other component in the longitudinal direction 110, both during engagement and disengagement.

In some embodiments, the thread channel 122 includes the axial stop 124, which may comprise a distal edge of a thread 132 of the electrode holder 120. The axial stop 124 extends radially inward and is configured to physically contact the rim 118 of the electrode 102 to prevent further axial advancement of the electrode 102 within the thread channel 122. Specifically, the axial stop 124 and the rim 118 are configured to physically contact/interact with each other to prevent further advancement of the electrode 102 beyond the axial stop 124 of the electrode holder 120 along the longitudinal axis 110. In addition, no rotation of the electrode 102 within the electrode holder 120 can occur during the axial advancement of the electrode 102 within the thread channel 122 (i.e., prior to the physical contact between the rim 118 and the axial stop 124), which may cause misalignment of the threads 114, 132 on the two components. Rotation is only permitted after the electrode 102 is fully inserted in the electrode holder 120, which is represented by the axial stop 124 of the electrode holder 120 contacting the rim 118 of the electrode 102, at which position threads 114 on the electrode 102 are properly positioned relative to the threads 132 on the electrode holder 120 to permit rotational threading. In such an inserted position, each thread region 112 of the electrode 102 faces a smooth region 134 of the electrode holder 120 and each smooth region 116 of the electrode 102 faces a thread region 130 of the electrode holder 120. Thus, rotation of the electrode 102 inside of the electrode holder 120 is only allowed after the electrode 102 slides to a stopping position within the thread channel 122 of the electrode holder 120 in the aligned position along the longitudinal axis 110. Further, the physical contact between the axial stop 124 of the electrode holder 120 and the rim 118 of the electrode 102 is adapted to establish a current conduction path 202 between the electrode 102 and the plasma arc torch 100 via the electrode holder 120.

In some embodiments, the electrode holder 120 further includes a pliable member 150, such as a canted coil spring, circumferentially coupled to an internal surface of the electrical holder 120 within the thread channel 122. In some embodiments, the pliable member 150 is conductive. The pliable member 150 can be located adjacent to the thread region(s) 130 of the electrode holder 120, such as immediately proximal to the thread region(s) 130. Thus, the pliable member 150 is also proximal to the axial stop 124 of the electrode holder 120. In some embodiments, the pliable member 150 is coupled to an internal surface of the electrode holder 120 by a retaining feature, such as an elliptical channel 128 disposed into a circumferential internal surface of the electrode holder 120 proximal to the thread region(s) 130. Therefore, the pliable member 150 is elliptically shaped when housed within the elliptical channel 128. In some embodiments, the pliable member 150 is made from an electrically conductive material.

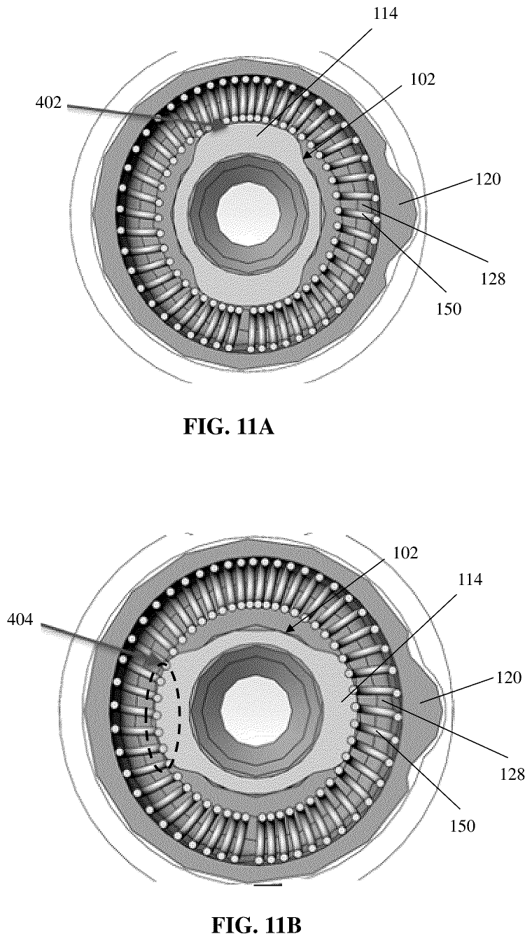

In general, the pliable member 150 is situated and configured such that when the electrode 102 is radially rotated relative to the electrode holder 120 for engaging the threads 114, 132 of the two components, at least one of the threads 114 of the electrode 102 (e.g., the proximal-most threads 114 of the electrode 102) physically contacts and progressively compresses the pliable member 150 in the elliptical channel 128 of the electrode holder 120. FIGS. 11A and 11B illustrate top sectional views of the relative positions of the threads 114 of the electrode 102 with respect to the pliable member 150 within the thread channel 122 of the electrode holder 120 of FIG. 8 prior to rotation and after rotation, respectively, according to some embodiments of the present invention. As shown in FIG. 11A, prior to rotation (e.g., 0° rotation), the elliptical channel 128 is configured to allow no physical contact between the threads 114 of the electrode 102 and the pliable member 150 located in the elliptical channel 128 of the electrode holder 120. This is due to the threads 114 of the electrode 102 being radially aligned with the major axis of the elliptical channel 128, thereby creating a sufficient clearance 402 to not permit physical contact between the components.

During rotation, at least one thread (e.g., the proximal-most threads 114) of the electrode 102 progressively compresses the pliable member 150 in the elliptical channel 128 to create progressively better electrical contact with increased electrical conductivity and progressively decreased electrical resistivity between the proximal region of the electrode 102 and the electrode holder 120. Rotation stops when the threads 114 of the electrode 102 fully engage the threads 132 of the electrode holder 120. In some embodiments, the degree of rotation required to achieve the full engagement is less than 360 degree and is dependent on the number of thread regions and smooth regions disposed on a body of each component. FIGS. 11A and 11B show that the electrode 102 includes two thread regions 112 interspersed between two smooth regions 116, such that each thread region 112 is between a pair of smooth regions 116. In a complementary fashion, the electrode holder 120 includes two thread regions 130 interspersed between smooth regions 134, such that each thread region 130 is between a pair of smooth regions 134. Thus, rotating the electrode 102 about 90° relative to the electrode holder 120 is adapted to engage the two components.

In some embodiments, the thread(s) of one thread region is discontinuous from the thread(s) of an adjacent/opposing thread region for each of the components 102, 120. That is, for each component, the pitch of each thread does not create a continuous helical path from one thread region to the next. In addition, for component 102 or 120, a thread of one thread region is physically and orientationally separate from another thread of an adjacent/opposing thread region. This is to prevent the thread of one thread region of one component from accidentally engaging the thread of an adjacent/opposing thread region of the other component in the rotational path during disengagement. For example, during disengagement, when threads 114 of a thread region 112 of the electrode 102 is radially rotated away from the engaged position, the threads 114 of a thread region 112 of the electrode 102 are prevented from further engagement with the threads 132 of the electrode holder 120 of an adjacent/opposing thread region 130 in the rotational path because the threads 114 of a thread region 112 of the electrode 102 cannot align with the adjacent thread 132 of the electrode holder 120. Further, the discontinuous thread rotational path of a component from one thread region to the next, such as the threads 114 of the electrode 102, prevents a corresponding thread 132 of the electrode holder 120 from over-rotating and further engaging with the threads 114 of a second engagement region 112 of the electrode 102 once the thread 132 is in a locked/engaged position with the thread 114 of a first engagement region 112.

FIG. 11B illustrates an exemplary engaged position between the threads 114, 132 of the electrode 102 and the electrode holder 120 after a 90° rotation. As shown, the proximal-most threads 114 of the electrode 102 are rotated into the major axis of the elliptical channel 128 to physically contact and compress the pliable member 150 therein. This also creates a current path 404 between the threads of the electrode 102 and the pliable member 150, as illustrated in FIG. 11B. This current path 404 can be established when the electrode 102 is rotated within the electrode holder 120 by less than 90° to contact the pliable member 150. Further, the performance (e.g., conductivity) of the current path 404 is independent of electrode thread torque between the threads 114, 132 of the electrode 102 and the electrode holder 120.

In some embodiments, yet another current path 406 (illustrated in FIG. 8) is established when the threads 114, 132 of the electrode 102 and electrode holder 120 physical contact each other after the rotational engagement. Therefore, at least three electrical conduction paths are possible between the electrode 102 and the electrode holder 120 of the plasma arc torch 100. The first conduction path 202 is established between the rim 118 of the electrode 102 and the axial stop 124 of the electrode holder 120 when the electrode 102 is fully seated within the thread channel 122 of the electrode holder 120 with no further axial advancement possible. The second conduction path 404 is established between at least one thread 114 of the electrode 102 and the pliable member 150 retained against the electrode holder 120 within the elliptical channel 128 as the electrode 102 is radially rotated within the electrode holder 120. The third conduction path 406 is established when the one or more threads 132 of the thread channel 122 within the electrode holder 120 physically contact the one or more threads 114 of the electrode 102 to engage the two components.

In some embodiments, the axial insertion/advancement of the electrode 102 in the electrode holder 120 prior to rotating the electrode 102 relative to the electrode holder 120 to engage the two components does not establish any physical connection between the electrode 102 and the pliable member 150 or between the threads 114, 132 of the electrode 102 and the electrode holder 120. In some embodiments, the axial insertion/advancement of the electrode 102 into the electrode holder 120 establishes physical contact between the electrode 102 and a side interior surface of the electrode holder 120 of the plasma arc torch 100, thereby establishing a fourth current conduction path between the electrode 102 and the electrode holder 120 during the insertion/advancement.

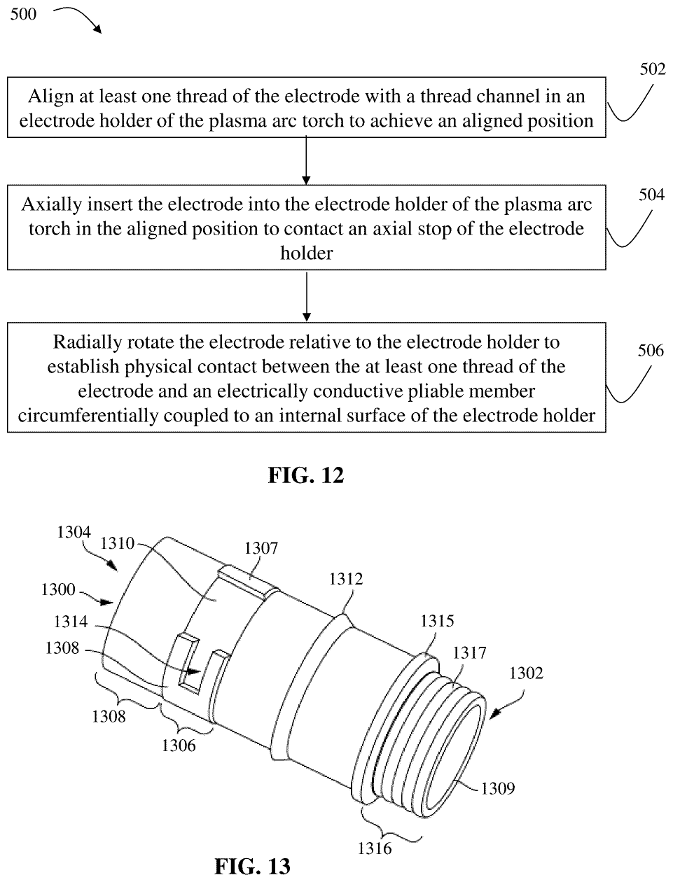

FIG. 12 illustrates an exemplary method 500 for securing and enabling electrical conduction between the electrode 102 and the electrode holder 120 of the plasma arc torch 100 of FIG. 8, according to some embodiments of the present invention. At step 502, each of the thread regions 112 of the electrode 102 is radially aligned with a smooth region 134 within the thread channel 122 of the electrode holder 120. Conversely, each of the smooth regions 116 of the electrode 102 can be radially aligned with a thread region 130 within the thread channel 122 of the electrode holder 120. In some embodiments, the thread regions of both the electrode holder 120 and the electrode 102 are complementary. That is, the location and orientation of the threads on one thread region are substantially the same as those of a different thread region associated with the same or different components. In addition, the thread regions and smooth regions can be rotationally symmetrical about each of the components. In view of such geometry, the radial alignment between the components at step 502 can be achieved in several rotational positions, relatively independent of the angle of insertion of the electrode 102 into the thread channel 122 of the electrode holder 120.

At step 504, the electrode 102 is axially inserted along the longitudinal direction 110 into the thread channel 122 of the electrode holder 120 while being maintained in the radially aligned orientation/position. The insertion can be accomplished without any rotation. In some embodiments, the axial advancement stops when the rim 118 of the electrode 102 encounters the axial stop 124 of the electrode holder 120 to reach an inserted position. In some embodiments, the two components are prevented from rotating relative to each other until the inserted position is reached, at which position the threads 114, 132 of the two components are aligned to permit rotation. In this inserted position, the current conduction path 202 can be established between the electrode 102 and the plasma arc torch 100 via the rim 118 of the electrode 102 and the axial stop 124 of the electrode holder 120.

At step 506, in the inserted position, the electrode 102 is rotated in one direction relative to the electrode holder 120 to lock the threads 114 of at least one thread region 112 of the electrode 102 with the threads 132 of an adjacent thread region 130 of the electrode holder 120 in the rotational path, thereby securing the components to one another. The amount of rotation required to achieve maximum engagement at the locked position can be less than 360°, such as less than or equal to about 60°, 900 or about 180°. The ultimate physical engagement between the threads 114, 132 establishes the current conduction path 406. Further, during rotation of the electrode 102 relative to the electrode holder 120, at least one thread 114 (e.g., the proximal-most thread(s)) of the electrode 102 progressively and laterally compresses the conductive pliable member 150 that is circumferentially coupled to a circumferential interior surface of the electrode holder 120 housed within the elliptical channel 128. The progressive lateral compression of the conductive pliable member 150 decreases electrical resistivity between the electrode 102 and the electrode holder 120 by establishing yet another current conduction path 404 that is independent of the threading torque for engaging the threads 114, 132.

In some embodiments, the plasma arc torch 100, including the electrode 102 being connected to the electrode holder 120 using the method 500 described with respect to FIG. 12, is operated at a current level of greater than about 120 amps, such as greater than about 220 amps. In general, the multiple current conduction paths established through such a connection (e.g., paths 202, 404 and/or 406) enable the plasma arc torch 100 to be operated at a relatively high current level.

To disengage the electrode 102 and the electrode holder 120, the electrode 102 can be rotated relative to the electrode holder 120 in an opposite direction by about the same number of degrees as the rotation used during the engagement process. While disengaging, the electrode 102 is prevented from rotating further in the opposite direction in the thread channel 122 of the electrode holder 120 when an edge of a thread region 112 of the electrode 102 encounters an edge of a thread region 130 of the electrode holder 120 in the rotational path. In this disengaged position, the threads 114 of the electrode 102 is rotated away from physical contact with the pliable member 150 in the elliptical channel 128 such that the clearance gap 402 reappears.

Even though the method 500 of FIG. 12 is described with the electrode 102 being rotatable relative to the electrode holder 120 during both the engagement and disengagement processes, the electrode holder 120 can also be rotated with respect to the electrode 102 to achieve the same effects.

It should be understood that various aspects and embodiments of the invention can be combined in various ways. Based on the teachings of this specification, a person of ordinary skill in the art can readily determine how to combine these various embodiments. Modifications may also occur to those skilled in the art upon reading the specification.

What is claimed is:

1. An electrode for a liquid-cooled plasma arc torch including a torch body and a cathodic element, the electrode comprising:
an electrode body having a proximal end and a distal end extending along a central longitudinal axis, the distal end including at least one emissive insert disposed therein proximate to a distal tip of the electrode body;
a retention region located at the proximal end of the electrode body, the retention region shaped to engage a first portion of the torch body for retaining the electrode within the torch body;
a current interface region located axially proximal to the retention region on the electrode body, the current interface region configured to slideably engage a second portion of the torch body while electrically communicating with the cathodic element of the plasma arc torch; and
a sealing member circumferentially disposed about the electrode body, the sealing member located axially distal to the current interface region and the retention region on the electrode body.

2. The electrode of claim 1, wherein the electrode is substantially symmetrical about the central longitudinal axis.

3. The electrode of claim 1, wherein the current interface region comprises about 11% of an axial length of the electrode.

4. The electrode of claim 1, wherein the retention region comprises about 11% an axial length of the electrode.

5. The electrode of claim 1, wherein the current interface region is directly cooled by a liquid coolant.

6. The electrode of claim 1, wherein about 22% of an axial length of the electrode is liquid cooled on an external surface of the electrode, and about 95% of the axial length of the electrode is liquid cooled on an internal surface of the electrode.

7. The electrode of claim 6, wherein about 78% of the axial length of the electrode is gas cooled on an external surface of the electrode.

8. The electrode of claim 1, further comprising a pliable component disposed about the current interface region to electrically communicate with the cathodic element while matingly engaging the torch body.

9. The electrode of claim 8, wherein the pliable component is a spring or a Louvertac® band.

10. The electrode of claim 1, wherein the sealing member is an O-ring.

11. The electrode of claim 1, wherein the retention region comprises a thread or detent configured to engage a complimentary feature of the torch body.

12. The electrode of claim 11, wherein upon engagement between the electrode and the torch body, physical contact between the thread or detent and the first portion of the torch body creates a second current interface region.

13. The electrode of claim 12, wherein upon engagement between the electrode and the torch body, the sealing member is adapted to be compressed to allow physical contact between the torch body and the electrode about the sealing member, thereby creating a third current interface region.

14. The electrode of claim 1, wherein the sealing member is configured to fluidly isolate the current interface region from a plenum of the plasma arc torch.

15. The electrode of claim 1, wherein at least about 22% of an axial length of the electrode is located proximal to the sealing member.

16. The electrode of claim 1, wherein a proximal portion of the electrode relative to the sealing member includes the current interface region for electrically communicating between the torch body and the electrode, and wherein a distal portion of the electrode relative to the sealing member is configured to seal, isolate, and direct one or more gas or liquid flows about the plasma arc torch.

17. The electrode of claim 1, further comprising a second sealing member circumferentially disposed about an external surface of the electrode at a widest diameter of the electrode.

18. The electrode of claim 11, wherein the retention region further comprises an axial stop disposed axially distal to the thread or detent.

19. The electrode of claim 18, wherein an axial distance between the axial stop and the proximal end of the electrode is about 0.4 inches.

20. A method of enabling electrical conduction and engagement between an electrode and a plasma arc torch that includes a torch body and a cathodic element, the method comprising:
providing the electrode having an electrically conductive body defining a proximal end and a distal end extending along a central longitudinal axis, the distal end including at least one emissive insert disposed therein proximate to a distal tip of the electrode body;
axially inserting the electrode into the torch body of the plasma arc torch;
engaging a retention region of the electrode body with a corresponding first portion of the torch body to retain the electrode within the torch body, wherein the retention region is located at the proximal end of the electrode body;
slidably engaging a current interface region of the electrode body with a second portion of the torch body, while establishing a first current conduction path between the electrode and the cathodic element of the plasma arc torch, wherein the current interface region of the electrode body is located axially proximal to the retention region; and
compressing a sealing member circumferentially disposed about the electrode body upon engagement between the electrode and the plasma arc torch to form a seal therebetween, wherein the sealing member is located axially distal to the current interface region and the retention region of the electrode body.

21. The method of claim 20, wherein engaging a retention region of the electrode body with a corresponding first portion of the torch body comprises rotationally engaging at least one thread or detent in the retention region of the electrode body with the corresponding first portion.

22. The method of claim 20, wherein engaging a retention region of the electrode body with a corresponding first portion of the torch body comprises slidably engaging the retention region with the first portion.

23. The method of claim 20, wherein the first current conduction path is established prior to the engagement between the retention region of the electrode body and the corresponding first portion of the torch body.

24. The method of claim 20, wherein the current interface region of the electrode body comprises an electrically conductive pliable member circumferentially coupled to an external surface of the electrode body, the first current conduction path being established via the pliable member.

25. The method of claim 24, wherein the pliable component comprises a spring or a Louvertac® band.

26. The method of claim 20, further comprising establishing a second current conduction path between the electrode body and the torch body via physical contact established between the retention region of the electrode body and the corresponding first portion of the torch body upon engagement.

27. The method of claim 20, further comprising establishing a third current conduction path between the electrode body and the torch body via compression of the sealing member to create physical contact between the electrode body and the torch body about the sealing member upon engagement.

28. The method of claim 20, further comprising:
flowing a liquid coolant over the current interface region of the electrode body to cool the current interface region;
preventing, by the sealing member, the liquid coolant from flowing distally toward the distal tip of the electrode body; and
fluidly isolating, by the sealing member, the current interface region from a plenum of the plasma arc torch.

29. The method of claim 28, wherein at least about 22% of an axial length of the electrode is located proximal to the sealing member.

30. The method of claim 20, wherein axially inserting the electrode into the torch body comprises axially advancing the electrode body within the torch body until an axial stop of the electrode body physically contacts a corresponding stop within the torch body to prevent further axial advancement of the electrode body.

31. The method of claim 30, wherein an axial distance between the axial stop and the proximal end of the electrode is about 0.4 inches.

32. A method of enabling electrical conduction and engagement between an electrode and a plasma arc torch that includes a torch body and a cathodic element, the method comprising:
providing the electrode having an electrically conductive body defining a proximal end and a distal end extending along a central longitudinal axis, the distal end including at least one emissive insert disposed therein proximate to a distal tip of the electrode body;
axially inserting the electrode into the torch body of the plasma arc torch;
aligning the electrode relative to the torch using an axial alignment flange of the electrode while slidably engaging a current interface region of the electrode with the torch body to create an electrical conduction path between the electrode and the cathodic element, the electrical conduction path configured to pass a plasma cutting current; and
rotating the electrode relative to the torch body to engage a retention region of the electrode body with a corresponding portion of the torch body to retain the electrode within the torch body, wherein the retention region is located at the proximal end of the torch body.

33. The method of claim 32, wherein the aligning and the slidably engaging are substantially concurrent.

34. The method of claim 32, wherein the first current conduction path is established prior to the engagement between the retention region of the electrode body and the corresponding portion of the torch body.

35. The method of claim 32, wherein axially inserting the electrode into the torch body comprises axially advancing the electrode body within the torch body until an axial stop of the electrode body physically contacts a corresponding stop within the torch body to prevent further axial advancement of the electrode body.

36. The method of claim 35, wherein the engagement between the current interface region of the electrode with the torch body occurs prior to the physical contact between the axial stop of the electrode body and the corresponding stop within the torch body.
